(19) United States
(12) Patent Application Publication
(10) Pub. No.: US 2024/0353697 A1
(43) Pub. Date: Oct. 24, 2024

(54) OPTICAL MODULATOR ELEMENT, OPTICAL TRANSMITTER, AND OPTICAL TRANSCEIVER

(71) Applicant: FUJITSU OPTICAL COMPONENTS LIMITED, Kawasaki-shi (JP)

(72) Inventor: Kensuke OGAWA, Meguro (JP)

(73) Assignee: FUJITSU OPTICAL COMPONENTS LIMITED, Kawasaki-shi (JP)

(21) Appl. No.: 18/626,916

(22) Filed: Apr. 4, 2024

(30) Foreign Application Priority Data
Apr. 18, 2023 (JP) 2023-068091

(51) Int. Cl. G02F 1/025; G02F 1/015; H04B 10/43

(52) U.S. Cl. CPC G02F 1/025; G02F 1/0155; H04B 10/43

(57) ABSTRACT

An optical modulator element includes a rib optical waveguide, a first thin film, a first high-concentration doped region, and a first metal electrode. The rib optical waveguide includes a rib portion having a PN junction, a P-type slab region connected to a P-type region of the rib portion, and an N-type slab region connected to an N-type region of the rib portion. The first thin film is formed on the P-type slab region and has electron affinity different from electron affinity of a material for the P-type slab region. The first high-concentration doped region is a region in the P-type slab region, the region being at a position separate from the rib portion. The first metal electrode is electrically connected to the first high-concentration doped region positioned outward in the P-type slab region having the first thin film formed over the P-type slab region.

### CROSS-REFERENCE TO RELATED APPLICATION

This application is based upon and claims the benefit of priority of the prior Japanese Patent Application No. 2023-068091, filed on Apr. 18, 2023, the entire contents of which are incorporated herein by reference.

### FIELD

The embodiments discussed herein are related to optical modulator elements, optical transmitters, and optical transceivers.

### BACKGROUND

In recent years, with the increase in communication capacity of data centers and 5G fronthaul and backhaul, for example, the demand for large-capacity optical fiber communication is increasing, and optical transceivers using optical modulator elements that modulate electric signals into optical signals are thus in widespread use. Optical modulator elements used in optical transceivers implement high-speed communication while reducing optical loss.
Patent Literature 1: U.S. Patent Application Publication No. 2022/0187635
Patent Literature 2: U.S. Patent Application Publication No. 2022/0026747
Patent Literature 3: U.S. Patent Application Publication No. 2022/0252911

When the electric field of the guided mode is extended in an optical modulator element, higher-order modes are generated, and interference between the higher-order modes reduces the extinction ratio and the optical modulation intensity of an optically modulated signal, increases bit errors, and thus reduces the quality of the optical signal. What is more, when the higher-order modes are generated, optical energy transitions from the fundamental mode to the higher-order modes and optical loss is generated.

### SUMMARY

According to an aspect of an embodiment, an optical modulator element includes a rib optical waveguide, a first thin film, a first high-concentration doped region and a first metal electrode. The rib optical waveguide includes a rib portion having a PN junction, a P-type slab region connected to a P-type region of the rib portion, and an N-type slab region connected to an N-type region of the rib portion. The first thin film is formed on the P-type slab region and has electron affinity different from electron affinity of a material for the P-type slab region. The first high-concentration doped region in the P-type slab region is at a position separate from the rib portion. The first metal electrode electrically is connected to the first high-concentration doped region positioned outward in the P-type slab region having the first thin film formed on the P-type slab region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a schematic cross section of an optical modulator element according to a first embodiment;

FIG. 2 is a diagram illustrating an example of a dopant arrangement in the optical modulator element according to the first embodiment;

FIG. 3A is a diagram illustrating an example of an electric field distribution of the guided mode of the optical modulator element according to the first embodiment;

FIG. 3B is a diagram illustrating an example of an electric field distribution of the guided mode of an optical modulator element of a comparative example.

FIG. 4 is a diagram illustrating an example of electric field profiles of the fundamental modes in the optical modulator element of the comparative example and the optical modulator element according to the first embodiment;

FIG. 5 is a diagram illustrating an example of band gaps for Si and Ge;

FIG. 6 is a diagram illustrating an example of relations between mobility of electrons and holes and impurity concentration;

FIG. 7 is a diagram illustrating an example of correspondence relations between RF frequency and EO response;

FIG. 8 is a diagram illustrating an example of a dopant arrangement in an optical modulator element according to a second embodiment;

FIG. 9 is a diagram illustrating an example of a schematic cross section of a thin film in the optical modulator element according to the second embodiment;

FIG. 10 is a diagram illustrating an example of a dopant arrangement in an optical modulator element according to a third embodiment;

FIG. 11 is a diagram illustrating an example of a schematic cross section of the optical modulator element according to the third embodiment;

FIG. 12 is a diagram illustrating an example of a schematic cross section of another optical modulator element;

FIG. 13 is a block diagram illustrating an example of an optical transceiver according to an embodiment; and

FIG. 14 is a diagram illustrating an example of a schematic cross section of an optical modulator element of a comparative example.

### DESCRIPTION OF EMBODIMENTS

FIG. 14 is a diagram illustrating an example of a schematic cross section of an optical modulator element 100 of a comparative example. The optical modulator element 100 illustrated in FIG. 14 has a rib waveguide 101 and a metal electrode 103 electrically connected to the rib waveguide 101 and connected to a signal electrode 104. The rib waveguide 101 includes a core 102 having a rib shape and has an upper cladding layer 106 and a lower cladding layer 105 that sandwich the core 102. The core 102 has a rib portion 111, a slab portion 112 connected to both ends of the rib portion 111, and a thin film 113 formed on the slab portion 112.

The rib portion 111 has a P-type region 111A and an N-type region 111B that form a lateral PN junction. The slab portion 112 has a P-type slab region 112A connected to the P-type region 111A, and an N-type slab region 112B connected to the N-type region 111B. The thin film 113 has a first thin film 113A formed on the P-type slab region 112A, and a second thin film 113B formed on the N-type slab region 112B. The metal electrode 103 has a first metal electrode 103A electrically connected to the first thin film 113A, and a second metal electrode 103B electrically connected to the second thin film 113B. The first metal electrode 103A is electrically connected to a first signal electrode 104A in the signal electrode 104, and the second metal electrode 103B is electrically connected to a second signal electrode 104B in the signal electrode 104.

The first thin film 113A is formed of a semiconductor material having electron affinity different from that of a material forming the P-type slab region 112A. The electron affinity of a semiconductor is energy obtained when one electron is moved from an external vacuum level to the bottom of the conductor of the semiconductor.

The second thin film 113B is formed of a semiconductor material having electron affinity different from that of a material forming the N-type slab region 112B. The first thin film 113A is formed on the P-type slab region 112A, with a gap region 114A (114: width g11) between the first thin film 113A and a side wall of the P-type region 111A of the rib portion 111. Furthermore, the second thin film 113B is formed on the N-type slab region 112B, with a gap region 114B (114: width g12) between the second thin film 113B and a side wall of the N-type region 111B of the rib portion 111.

A Si—Ge heterojunction is formed at an interface between the first thin film 113A and the P-type slab region 112A. A Si—Ge heterojunction is also formed at an interface between the second thin film 113B and the N-type slab region 112B.

Therefore, electric resistance between the first signal electrode 104A and the second signal electrode 104B is reduced by high-mobility carriers formed at the heterojunctions in the optical modulator element 100 of the comparative example. As a result, an RC time constant given by a product of series electric resistance R and electrostatic capacitance C is able to be decreased.

The first thin film 113A and the second thin film 113B extend to positions directly beneath the metal electrode 103 in the optical modulator element 100 of the comparative example. To increase mobility of electrons and holes by forming heterojunctions, a material having a refractive index higher than that of a material forming the core 102 having the rib shape is used as the material forming the first thin film 113A and the second thin film 113B. In a case where designing and manufacturing are implemented on a platform based on silicon photonics suitable for mass production, the core 102 is formed of, for example, a silicon crystal and the first thin film 113A and the second thin film 113B are formed of, for example, a germanium crystal or a silicon-germanium mixed crystal. That is, the first thin film 113A and the second thin film 113B have a refractive index higher than that of the core 102. As a result, the electric field of the guided mode is extended to the metal electrode 103 and the slab portion 112 directly beneath the metal electrode 103, and thus optical absorption by the metal electrons and carriers is caused and optical loss is generated. For example, in a case where the slab portion 112 directly beneath the metal electrode 103 is a high-concentration doped region, the electric field is extended to the high-concentration doped region and thus optical absorption by the metal electrons and high-concentration carriers is caused and optical loss is generated.

Furthermore, in a case where a material other than silicon and germanium, for example, a GaAs material, which is one of III-V compounds, is used in the optical modulator element 100, the core 102 includes an AlGaAs mixed crystal and the first thin film 113A and the second thin film 113B include a GaAs crystal. However, because the GaAs crystal has a refractive index higher than that of the AlGaAs mixed crystal, optical loss is still generated.

What is more, when the electric field of the guided mode is extended in the optical modulator element 100, higher-order modes are generated, and interference between the higher-order modes reduces the extinction ratio and the optical modulation intensity of an optically modulated signal, increases bit errors, and thus reduces the quality of the optical signal. In addition, when the higher-order modes are generated, optical energy transitions from the fundamental mode to the higher-order modes and optical loss is generated.

Furthermore, because the first thin film 113A and the second thin film 113B are directly beneath the metal electrode 103 in the optical modulator element 100, the first thin film 113A and the second thin film 113B need to be high in electric conductivity to achieve low-resistance contact with the metal electrode 103. A dopant thus needs to be distributed at a high concentration by ion implantation into the first thin film 113A and second thin film 113B and activated by annealing. For a heterojunction having lattice distortion, lattice relaxation is caused by increase in temperature due to the annealing and crystal defects are generated at the heterojunction interface. As a result, the electric resistance is increased by scattering due to the crystal defects and a small RC time constant is thus unable to be obtained. The crystal defects generated at the heterojunction interface are irregularly distributed in the wafer and tend to increase as the optical modulator element 100 is used over a long period of time and thus reduce mass productivity and reliability of the optical modulator element 100.

Therefore, there is a demand for an optical modulator element according to an embodiment that enables reduction of deterioration in quality of optical signals and reduction of optical loss while reducing generation of higher-order modes.

Preferred embodiments of the present invention will be explained with reference to accompanying drawings. The present invention is not to be limited by these embodiments. Furthermore, the following embodiments may be combined with one another as appropriate so long as no contradictions are caused by the combination.

### (a) First Embodiment

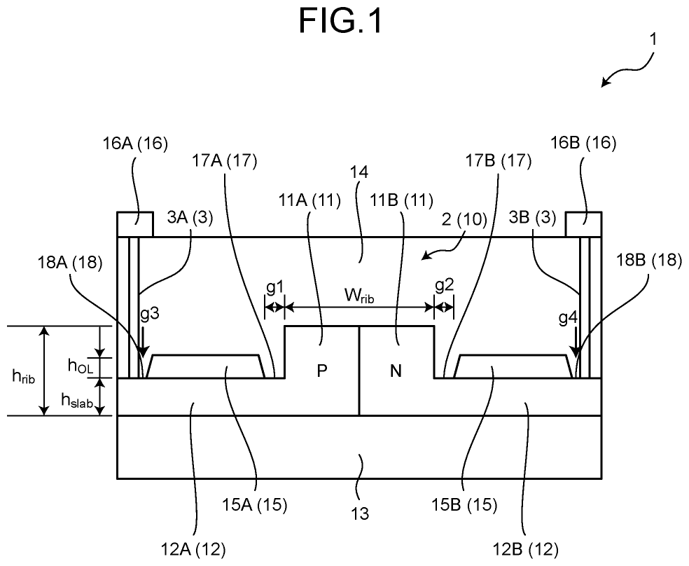

FIG. 1 is a diagram illustrating an example of a schematic cross section of an optical modulator element 1 according to a first embodiment. FIG. 1 is a cross section orthogonal to the direction of propagation of the fundamental mode of the optical modulator element 1. The optical modulator element 1 illustrated in FIG. 1 has a rib waveguide 2, and a metal electrode 3 electrically connected to both ends of the rib waveguide 2 and electrically connected to a signal electrode 16. The rib waveguide 2 has a core 10 having a rib shape, and an upper cladding layer 14 and a lower cladding layer 13 that sandwich the core 10. For convenience of description, although the lower cladding layer 13 is layered over a support substrate, illustration of the support substrate is omitted. The core 10 has a rib portion 11, a slab portion 12 connected to both ends of the rib portion 11, and a thin film 15 formed on the slab portion 12. The rib portion 11 has a P-type region 11A and an N-type region 11B. The slab portion 12 has a P-type slab region 12A connected to the P-type region 11A in the rib portion 11, and an N-type slab region 12B connected to the N-type region 11B in the rib portion 11. The thin film 15 has a first thin film 15A formed on the P-type slab region 12A, and a second thin film 15B formed on the N-type slab region 12B.

The metal electrode 3 has a first metal electrode 3A vertically penetrating through the upper cladding layer 14 and electrically connected to the P-type slab region 12A, and a second metal electrode 3B vertically penetrating through the upper cladding layer 14 and electrically connected to the N-type slab region 12B. The first metal electrode 3A is electrically connected to a first signal electrode 16A in the signal electrode 16. The second metal electrode 3B is electrically connected to a second signal electrode 16B in the signal electrode 16.

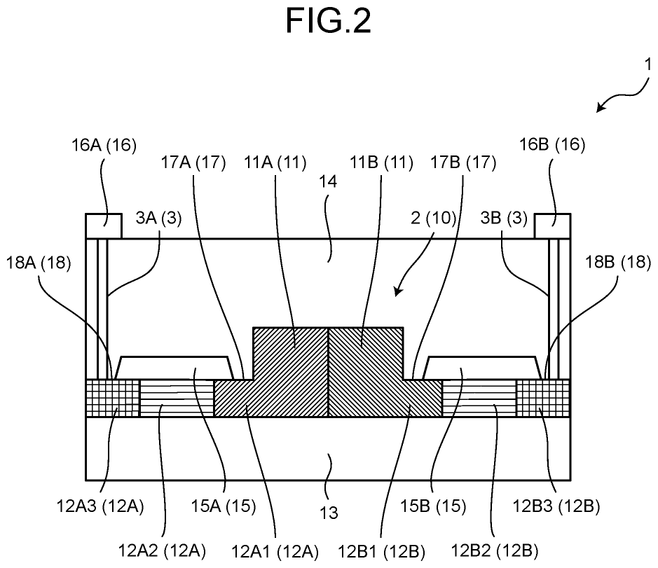

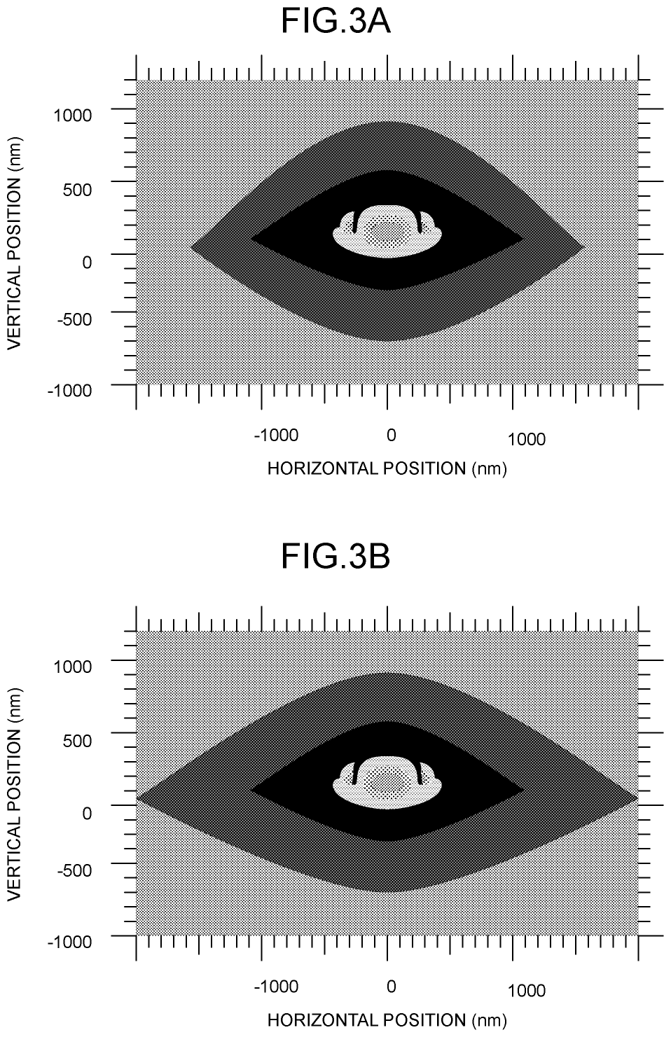

FIG. 2 is a diagram illustrating an example of a dopant arrangement in the optical modulator element 1 according to the first embodiment. The core 10 illustrated in FIG. 3 has a P region 12A1, a P+ region 12A2, a P++ region 12A3, an N region 12B1, an N+ region 12B2, and an N++ region 12B3. The P region 12A1 is formed of the P-type region 11A and part of the P-type slab region 12A, the part being connected with the P-type region 11A. The P+ region 12A2 is a highly doped region and is part of the P-type slab region 12A, the part being connected to the P region 12A1. The P++ region 12A3 is a high-concentration doped region and is part of the P-type slab region 12A, the part being connected to the P+ region 12A2. The P region 12A1 has a doping concentration lower than that of the P+ region 12A2 and the doping concentration of the P+ region 12A2 is lower than that of the P++ region 12A3. The P++ region 12A3, which is the high-concentration doped region, is a region having the highest doping concentration in the P-type slab region 12A connected with the P-type region 11A of the rib portion 11.

The first metal electrode 3A is electrically connected to the P++ region 12A3 positioned outward in the P-type slab region 12A having the first thin film 15A formed thereon. That is, the first metal electrode 3A is electrically connected to the P++ region 12A3 positioned: outward in the P-type slab region 12A having the first thin film 15A formed thereon; and far from the rib portion 11. The P++ region 12A3 serves as a P-side contact region by being in contact with a bottom portion of the first metal electrode 3A. The P++ region 12A3 is in contact with the first thin film 15A and horizontally overlaps the first thin film 15A. As a result, holes are drawn into and distributed in the first thin film 15A that is undoped and has higher electron affinity to holes than the P-type slab region 12A, high-mobility holes will then be present as two-dimensional carriers in the first thin film 15A, and the series electric resistance is thereby able to be reduced. The horizontal overlap between the P++ region 12A3 and the first thin film 15A is about 50 nm. Furthermore, the horizontal overlap between the P++ region 12A3 and the first thin film 15A is preferably about 100 nm, in view of the positioning precision of patterning using an optical mask at the processing step.

The N region 12B1 is formed of the N-type region 11B and part of the N-type slab region 12B, the part being connected with the N-type region 11B. The N+ region 12B2 is a highly doped region and is part of the N-type slab region 12B, the part being connected to the N region 12B1. The N++ region 12B3 is a high-concentration doped region and is part of the N-type slab region 12B, the part being connected to the N+ region 12B2. The second metal electrode 3B is electrically connected to the N++ region 12B3 positioned outward in the N-type slab region 12B having the second thin film 15B formed thereon. That is, the second metal electrode 3B is electrically connected to the N++ region 12B3 positioned: outward in the N-type slab region 12B having the second thin film 15B formed thereon; and far from the rib portion 11. The N++ region 12B3 serves as an N-side contact region by being in contact with a bottom portion of the second metal electrode 3B. The N region 12B1 has a doping concentration lower than that of the N+ region 12B2 and the doping concentration of the N+ region 12B2 is lower than that of the N++ region 12B3. The N++ region 12B3, which is the high-concentration doped region, is a region having the highest doping concentration in the N-type slab region 12B connected with the N-type region 11B of the rib portion 11.

The N++ region 12B3 is in contact with the second thin film 15B and horizontally overlaps the second thin film 15B. The horizontal overlap between the N++ region 12B3 and the second thin film 15B is about 50 nm. Furthermore, the horizontal overlap between the N++ region 12B3 and the second thin film 15B is preferably about 100 nm in view of positioning precision of patterning using an optical mask at the processing step.

The doping concentration in each region is set as follows, for example. The P region 12A1 has a doping concentration of, for example, 5×10\hat{ }17 cm\hat{ }-3, the P+ region 12A2 has a doping concentration of, for example, 5×10\hat{ }18 cm\hat{ }-3, and the P++ region 12A3 has a doping concentration of, for example, 1×10\hat{ }20 cm\hat{ }-3. The N region 12B1 has a doping concentration of, for example, 2×10\hat{ }17 cm\hat{ }-3, the N+ region 12B2 has a doping concentration of, for example, 5×10\hat{ }18 cm\hat{ }-3, and the N++ region 12B3 has a doping concentration of, for example, 1×10\hat{ }20 cm\hat{ }-3. However, the arrangement and settings for these doping densities are just examples, and may be modified as appropriate without being limited to these examples.

The first metal electrode 3A vertically penetrates through the upper cladding layer 14 and is electrically connected to the P++ region 12A3 in the P-type slab region 12A. The second metal electrode 3B vertically penetrates through the upper cladding layer 14 and is electrically connected to the N++ region 12B3 in the N-type slab region 12B.

In a case where the first thin film 15A and the second thin film 15B have a thickness hOL, the slab portion 12 has a thickness hslab, and the rib portion 11 has a thickness hrib, the thickness hrib of the rib portion 11 of the optical modulator element 1 is thicker than a total thickness that is a total of the thickness hslb of the slab portion 12 and the thickness hOL of the first thin film 15A (or second thin film 15B). That is, as to the thickness hrib of the rib portion 11, hrib>hslab+hOL.

A gap region 17 has been formed between the rib portion 11 and the thin film 15. A first gap region 17A having a width g1 has been formed between the rib portion 11 and the first thin film 15A. Furthermore, a second gap region 17B having a width g2 has also been formed between the rib portion 11 and the second thin film 15B. However, modifications may be made as appropriate, and the first gap region 17A and the second gap region 17B may be not provided, in accordance with the demanded optical loss in the optical modulator element 1.

A gap region 18 has been formed between the metal electrode 3 and the thin film 15. The gap region 18 has a third gap region 18A having a width g3 and formed between the first thin film 15A and the first metal electrode 3A, and a fourth gap region 18B having a width g4 and formed between the second thin film 15B and the second metal electrode 3B.

The upper cladding layer 14 covers the core 10, the first thin film 15A, and the second thin film 15B. Therefore, the upper cladding layer 14 is also present over the first gap region 17A, the second gap region 17B, the third gap region 18A, and the fourth gap region 18B.

Because the third gap region 18A is present between the first thin film 15A and the first metal electrode 3A, the first thin film 15A is laterally finite. Furthermore, because the fourth gap region 18B is present between the second thin film 15B and the second metal electrode 3B, the second thin film 15B is also laterally finite. That is, the first thin film 15A and the second thin film 15B are laterally finite. Therefore, horizontal extension of the electric field of the fundamental mode propagating through the core 10 is able to be lessened and extension of the electric field of the fundamental mode propagating through the core 10 to the high-concentration doped regions (the P++ region 12A3 and N++ region 12B3) directly beneath the first metal electrode 3A and the second metal electrode 3B is able to be lessened. As a result, optical loss and generation of higher-order modes are able to be reduced.

Because the first thin film 15A and the second thin film 15B, which are undoped, are arranged in the optical modulator element 1A without being doped intentionally, the series electric resistance is able to be reduced and the RC time constant is able to be decreased.

Setting a width wrib of the rib portion 11 to, for example, 450 to 500 nm enables reduction of generation of higher-order modes in the rib portion 11, formation of the core 10 having less influence of damaged side walls, and use of the core 10 as a basic structure for an optical modulator low in optical loss. The core 10 is made of, for example, a silicon crystal, and the upper cladding layer 14 and the lower cladding layer 13 are both made of silica. The first metal electrode 3A and the second metal electrode lithography 3B are formed by thin film deposition of aluminum, optical, or etching. The thickness hrib of the rib portion 11 is, for example, 220 nm, the thickness hslab of the P-type slab region 12A and the N-type slab region 12B is, for example, 100 nm, and the thickness hOL of the first thin film 15A and second thin film 15B is, for example, 10 nm. The first thin film 15A and the second thin film 15B are separate from the first metal electrode 3A and the second metal electrode 3B, and are positioned higher than bottom surfaces of the first metal electrode 3A and the second metal electrode 3B.

The width g1 of the first gap region 17A and the width g2 of the second gap region 17B are, for example, 50 to 200 nm. A case where the width g1 of the first gap region 17A and the width g2 of the second gap region 17B are made narrower than 50 nm is now supposed, for example. In this case, the electric field of the fundamental mode is extended to the P-type slab region 12A and the N-type slab region 12B by the first thin film 15A and the second thin film 15B that are made of a germanium crystal having a refractive index higher than that of the core 10. Therefore, in view of the positioning precision in the processing, the width g1 of the first gap region 17A and the width g2 of the second gap region 17B are preferably in a range of, for example, 50 to 200 nm.

To maintain the shape symmetry of the core 10 and avoid polarization rotation, the first thin film 15A and the second thin film 15B have a width of, for example, 700 nm. Furthermore, the width g3 of the third gap region 18A and the width g4 of the fourth gap region 18B are, for example, 500 nm. In a case where the width g3 of the third gap region 18A and the width g4 of the fourth gap region 18B are set to 500 nm, extension of the electric field of the fundamental mode to the P++ region 12A3 and the N++ region 12B3 is able to be lessened.

FIG. 3A is a diagram illustrating an example of an electric field distribution of the guided mode of the optical modulator element 1 according to the first embodiment. FIG. 3B is a diagram illustrating an example of an electric field distribution of the guided mode of the optical modulator element 100 of the comparative example. The core 10 of the optical modulator element 1 is formed of, for example, a silicon crystal, and the first thin film 15A and the second thin film 15B are formed of, for example, a germanium crystal. Furthermore, the core 102 of the optical modulator element 100 is also formed of, for example, a silicon crystal, and the first thin film 113A and the second thin film 113B are also formed of, for example, a germanium crystal. The silicon crystal has a refractive index of 3.48 and the germanium crystal has a refractive index of 4.28. The horizontal extension of the electric field distribution of the guided mode of the optical modulator element 1 illustrated in FIG. 3A is less than that of the electric field distribution of the guided mode of the optical modulator element 100 of the comparative example illustrated in FIG. 3B.

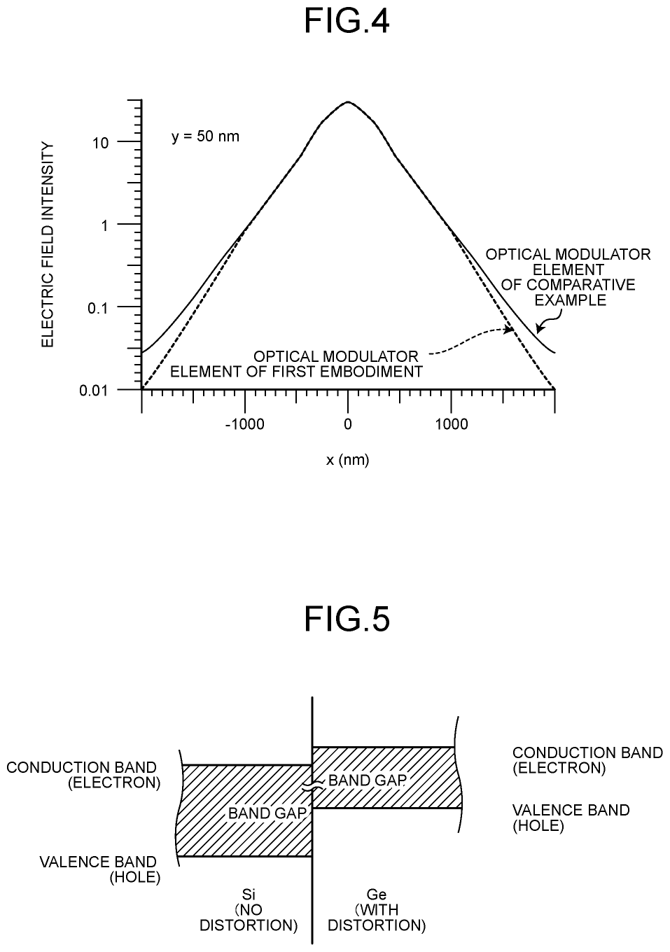

FIG. 4 is a diagram illustrating an example of electric field profiles of the fundamental modes in the optical modulator element 100 of the comparative example and the optical modulator element 1 of the first embodiment. As to the electric field distributions illustrated in FIG. 4, waveforms at a position y=50 nm along a vertical direction of the profiles of the fundamental modes in FIG. 3A and FIG. 3B, that is, along a y-axis indicating the position along the vertical direction have been extracted and displayed.

In the optical modulator element 1 according to the first embodiment, as illustrated in FIG. 4, the extension of the electric field distribution of the fundamental mode along the boundary surface (horizontal surface) between the core 10 and the lower cladding layer 13, that is, along an x-axis has been reduced. The extension of the electric field distribution is able to be reduced in the optical modulator element 1 according to the first embodiment, as compared with the optical modulator element 100 of the comparative example, and optical loss and generation of higher-order modes are thus able to be reduced. What is more, because the slab portion 12 in contact with the metal electrode 3 has the P++ region 12A3 and the N++ region 12B3 that are high-concentration doped regions, optical absorption by the metal electrons and high-concentration carriers is able to be reduced to a half or less of that in the comparative example.

FIG. 5 is a diagram illustrating an example of band gaps for Si and Ge. In a case where the core 10 is formed of, for example, a silicon crystal, and the first thin film 15A and the second thin film 15B are formed of, for example, a germanium crystal, the band arrangement of the heterojunction is Type II, as illustrated in FIG. 5. Electrons are distributed in silicon lower in band-edge energy than germanium (higher in electron affinity than germanium). However, the band offset of the conduction band is small (the difference in electron affinity is small) and electrons are thus also distributed in germanium at room temperature. Therefore, conduction through both the silicon and undoped germanium routes increases the mobility.

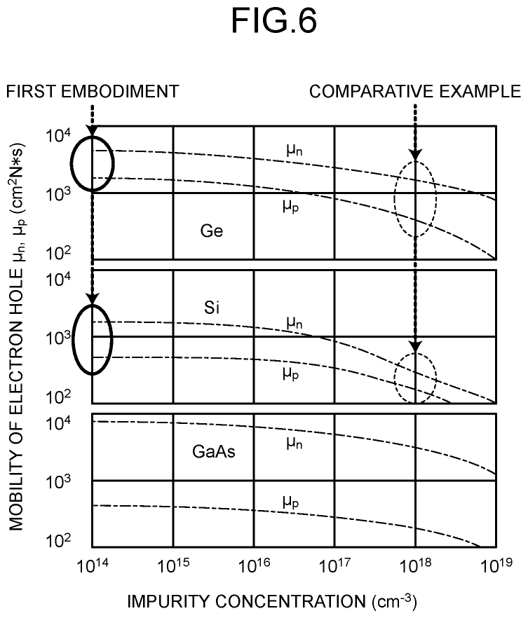

FIG. 6 is a diagram illustrating an example of relations between mobility of electrons and holes and impurity concentration. A comparative example illustrated in FIG. 6 is an optical modulator element without the thin film 15. Without being directly connected to the first thin film 15A and the second thin film 15B where high-mobility two-dimensional holes and electrons are distributed, the first metal electrode 3A and the second metal electrode 3B are connected to the P++ region 12A3 and N++ region 12B3, and the dopant configuration illustrated in FIG. 2 is adopted. As a result, optimization of electric properties (increase in speed due to reduction in electric resistance) and optimization of optical characteristics (reduction of optical loss and reduction of generation of higher-order modes, due to reduction of mode extension) are both able to be achieved.

Because impurity ions from the dopant are not distributed in the first thin film 15A and the second thin film 15B, scattering due to the ionized impurity is thus not caused and mobility of electrons and holes increases. The increase in the mobility is able to be estimated from the characteristic curves in FIG. 6. At a silicon-germanium heterojunction, conduction of holes in undoped germanium significantly increases mobility of the holes. However, in view of the increase in the mobility of holes and electrons, the electric resistance in the optical modulator element 1 is able to be reduced to a half or less of that in a case where the first thin film 15A and the second thin film 15B are not included.

Furthermore, because the first thin film 15A and the second thin film 15B are not directly beneath the metal electrode 3, the first thin film 113A and the second thin film 113B do not need to have high electric conductivity to achieve low resistance contact with the metal electrode 3. As a result, crystal defects are not generated and mass productivity and reliability of the optical modulator element 1A are thus able to be improved.

Because the first thin film 15A and the second thin film 15B in the optical modulator element 1 according to the first embodiment are laterally finite, the first metal electrode 3A and the P-type slab region 12A are directly connected to each other and the second metal electrode 3B and the N-type slab region 12B are directly connected to each other. As a result, the horizontal extension of the electric field distribution is lessened and optical loss and generation of higher-order modes are thereby able to be reduced. What is more, for example, because the first metal electrode 3A and the second metal electrode 3B are arranged to overlap the high-concentration doped regions, optical absorption is able to be reduced, as compared with the optical modulator element 100 of the comparative example. That is, generation of higher-order modes due to extension of the electric field of the guided mode is able to be reduced and quality deterioration of optical signals and optical loss are able to be reduced.

In the optical modulator element 1, the P++ region 12A3 having a carrier density higher than those in the P region 12A1 and P+ region 12A2 is in contact with the first thin film 15A and horizontally overlaps the first thin film 15A. As a result, carriers that are present in the P+ region 12A2 and P++ region 12A3 diffuse into and are distributed in the first thin film 15A. Therefore, the mobility in the first thin film 15A is able to be increased and the electric resistance is able to be reduced.

In the optical modulator element 1, the N++ region 12B3 having a carrier density higher than those in the N region 12B1 and N+ region 12B2 is in contact with the second thin film 15B and horizontally overlaps the second thin film 15B. As a result, carriers that are present in the N+ region 12B2 and N++ region 12B3 diffuse into and are distributed in the second thin film 15B. Therefore, the mobility in the second thin film 15B is able to be increased and the electric resistance is able to be reduced.

A boundary between the P region 12A1 and the P+ region 12A2 is directly beneath the first thin film 15A and horizontally overlaps the first thin film 15A. However, without being limited to such a configuration, modifications may be made as appropriate, and the boundary between the P region 12A1 and the P+ region 12A2 may be horizontally outside the first thin film 15A, that is, nearer to the rib portion 11 in the center than the first thin film 15A is.

Furthermore, a boundary between the N region 12B1 and the N+ region 12B2 is directly beneath the second thin film 15B and horizontally overlaps the second thin film 15B. However, without being limited to such a configuration, modifications may be made as appropriate, and the boundary between the N region 12B1 and the N+ region 12B2 may be horizontally outside the second thin film 15B, that is, nearer to the rib portion 11 in the center than the second thin film 15B is.

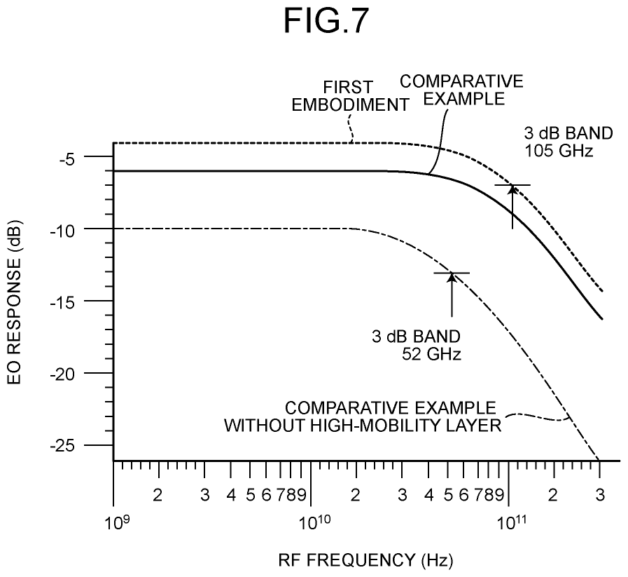

Other modifications may be made as appropriate, and an optical modulator, such as a phase modulation unit, may be formed by use of two of the optical modulator elements 1 according to this embodiment and arrangement of the two optical modulator elements 1 on two arms of a Mach-Zehnder interferometer. FIG. 7 is a diagram illustrating an example of results of a simulation of electro-optic frequency response of an optical modulator using the optical modulator element 1 according to the embodiment. The results of the simulation for the optical modulator adopting the optical modulator element 1 according to the embodiment are represented by a broken line, results of a simulation for an optical modulator adopting the optical modulator element 100 of the comparative example by a solid line, and results of a simulation for an optical modulator adopting an optical modulator element of another comparative example without a thin film by a dash dotted line. The optical modulator element 100 of the comparative example is the optical modulator element 100 illustrated in FIG. 14. The optical modulator element without a thin film includes a ribbed core having no high-mobility layer arranged directly above a slab portion thereof, the high-mobility layer being equivalent to the first thin film 113A and second thin film 113B where high-mobility holes or electrons are distributed. For convenience of description, the optical modulator adopting the optical modulator element 100 of the comparative example will be referred to as a first optical modulator and the optical modulator adopting the optical modulator element of the comparative example without the thin film will be referred to as a second optical modulator.

Parameters in the simulations for the optical modulators are as follows. As to dimensions of waveguides in the optical modulators, the rib width Wrib is 500 nm, the rib thickness hrib is 220 nm, and the waveguide length is 3 mm.

Optical loss in the waveguide of the optical modulator according to the embodiment is able to be estimated to be 0.4 dB/mm. In contrast, optical loss in the waveguides of the first optical modulator and second optical modulator of the comparative examples is able to be estimated to be 0.6 dB/mm, in view of loss due to higher-order modes.

That is, in each simulation, electric properties of an electric circuit formed of series electric resistance R and electrostatic capacitance C were obtained by numerical analysis, the obtained electric properties were input as frequency characteristics of the phase modulation unit serving as the optical modulator, and frequency response of optical interference intensity was obtained. The following values were used as the series electric resistance R and electrostatic capacitance C. As a result, the series electric resistance R of the optical modulator according to the embodiment and the first optical modulator of the comparative example is, for example, 1.7Ω, and the series electric resistance R of the second optical modulator is, for example, 3.5Ω. Furthermore, the electrostatic capacitance C of each of the optical modulator according to the embodiment and the first optical modulator and second optical modulator of the comparative examples is 1.2 pF (DC reverse bias of 3 V).

Therefore, as can be understood from the simulation results illustrated in FIG. 7, the optical loss in the optical modulator according to the embodiment is able to be made 2 dB less than the optical loss in the first optical modulator of the comparative example.

A case where the optical modulator element 1 according to the first embodiment is formed of a silicon-germanium material has been described as an example, but without being limited to this example, the optical modulator element 1 may be formed of a GaAs or InP material, which is a III-V compound. Furthermore, the example may be modified as appropriate, and GaAs or InP material may be combined with a silicon-germanium material. In a case where the optical modulator element 1 is formed of a GaAs material, the rib portion 11, the P-type slab region 12A, and the N-type slab region 12B may be formed of, for example, AlGaAs, and the first thin film 15A and second thin film 15B may be formed of, for example, GaAlAs. Furthermore, in a case where the optical modulator element 1 is formed of an InP material, the rib portion 11, the P-type slab region 12A, and the N-type slab region 12B may be formed of, for example, InP, and the first thin film 15A and second thin film 15B may be formed of, for example, GaInAs, and this example may also be modified as appropriate.

The embodiment enables provision of the optical modulator element 1 that enables reduction of: generation of higher-order modes due to extension of the electric field of the guided mode; deterioration in quality of optical signals; and optical loss.

A case where the first thin film 15A and second thin film 15B in the optical modulator element 1 according to the first embodiment are formed of a germanium crystal has been described as an example, but because lattice mismatch between a germanium crystal and a silicon crystal is large, the critical film thickness, at which lattice relaxation is not caused, is desirably 1 nm or less. However, when a germanium crystal is made by thin film deposition, lattice relaxation may be caused. Furthermore, the optical absorption edge wavelength for germanium is 1600 nm or longer and loss due to optical absorption may be generated in the C-band or O-band of optical communication.

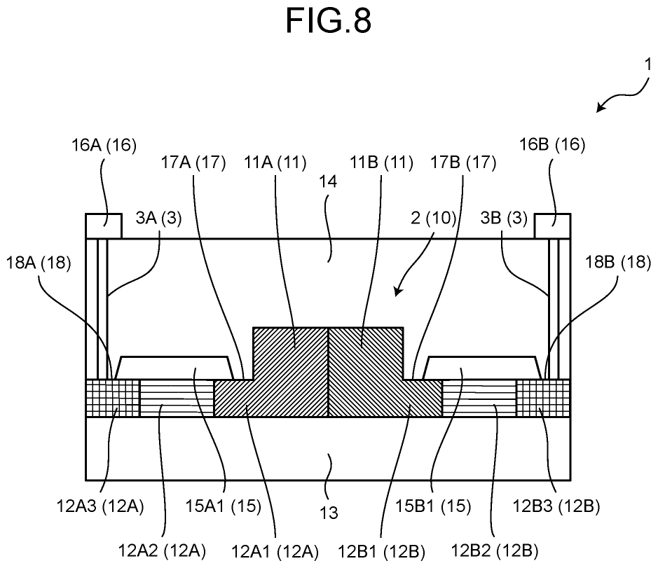

Therefore, an embodiment to address such situations will hereinafter be described as a second embodiment. By assignment of the same reference signs to components that are the same as those of the optical modulator element 1 according to the first embodiment, description of the same components and operation thereof will be omitted. FIG. 8 is a diagram illustrating an example of a dopant arrangement in an optical modulator element 1 according to the second embodiment.

### (b) Second Embodiment

For example, in a case where a silicon-germanium mixed crystal is used, the critical film thickness is able to be increased and the optical absorption edge wavelength is shortened, and loss due to optical absorption may thus be able to be reduced. Therefore, as illustrated in FIG. 8, instead of a germanium crystal, a silicon-germanium mixed crystal is used as a first thin film 15A1 and a second thin film 15B1.

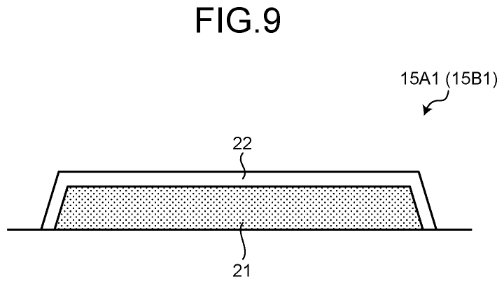

FIG. 9 is a diagram illustrating an example of a schematic cross section of a thin film 15 of the optical modulator element 1 according to the second embodiment. The first thin film 15A1 (second thin film 15B1) in the optical modulator element 1 illustrated in FIG. 9 has, instead of the thin film 15 of a germanium crystal, a high-mobility layer 21 of a silicon-germanium mixed crystal, and a covering layer 22 of a silicon crystal, the first thin film 15A1 being the thin film 15 using a silicon-germanium mixed crystal.

The higher the composition ratio of the germanium crystal, the more reduced the effective mass of holes, the more increased the mobility, and the more reduced the electric resistance. The reduction in electric resistance due to the increase in mobility, that is, increase in speed, and reduction in optical loss and increase in critical film thickness are both able to be achieved. For example, the composition ratio between the germanium crystal and the silicon crystal is preferably 0.3:0.7. In this case, the silicon-germanium mixed crystal is able to be layered up to a film thickness of about 10 nm without having any defects generated therein. Obtaining such a film thickness enables film thickness variation in thin film deposition to be lessened and variation in optical characteristics to be lessened.

The high-mobility layer 21 has a thickness of, for example, 10 nm, and the covering layer 22 has a thickness of, for example, 5 nm. The covering layer 22 enables prevention of generation of ionized defects on a surface of the high-mobility layer 21, for example. The covering layer 22 is formed of the silicon crystal, high-mobility electrons thus are present as two-dimensional carriers in the covering layer 22 made of the silicon crystal, and further reduction of electric resistance is thus enabled.

The thin film 15 (the first thin film 15A1 and the second thin film 15B1) of the optical modulator element 1 according to the second embodiment has the high-mobility layer 21 made of the silicon-germanium mixed crystal and the covering layer 22 made of the silicon crystal. As a result, the critical film thickness is able to be increased and the optical absorption edge wavelength is shortened, and loss due to optical absorption is thus able to be reduced.

A case where the optical modulator element 1 according to the second embodiment has the high-mobility layer 21 formed of the silicon-germanium mixed crystal and the covering layer 22 formed of the silicon crystal has been described as an example, but without being limited to this example, a germanium crystal or a III-V semiconductor material may be used. In a case where a GaAs material is used, the high-mobility layer 21 is formed of GaAs and the covering layer 22 is formed of GaAlAs. In a case where an InP material is used, the high-mobility layer 21 may be formed of GaInAs and the covering layer 22 may be formed of InP, and this may also be modified as appropriate.

### Third Embodiment

### (c) Third Embodiment

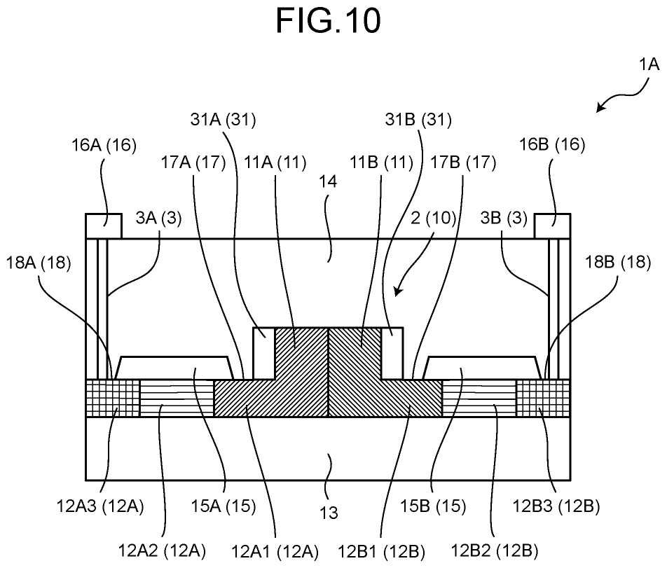

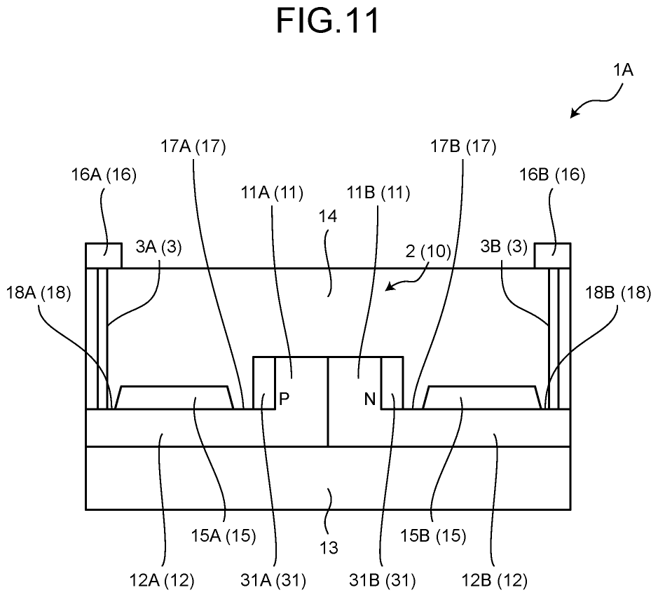

FIG. 10 is a diagram illustrating an example of a dopant arrangement in an optical modulator element 1A according to a third embodiment. FIG. 11 is a schematic cross-sectional diagram illustrating an example of the optical modulator element 1A according to the third embodiment. By assignment of the same reference signs to components that are the same as those of the optical modulator element 1 according to the first embodiment, description of the same components and operation thereof will be omitted. A rib portion 11 of the optical modulator element 1A illustrated in FIG. 10 and FIG. 11 has a P-type region 11A and an N-type region 11B. A first compensation doped region 31A (31) that has been N-doped with an impurity at a low concentration has been provided in a side wall portion of the P-type region 11A in the rib portion 11. The first compensation doped region 31A reduces optical loss by canceling out the carrier concentration at a side wall of the P-type region 11A. Furthermore, a second compensation doped region 31B (31) that has been P-doped with an impurity at a low concentration has been provided in a side wall portion of the N-type region 11B in the rib portion 11. The second compensation doped region 31B reduces optical loss by canceling out the carrier concentration at a side wall of the N-type region 11B.

In the optical modulator element 1A according to the third embodiment, the first compensation doped region 31A has been arranged in the side wall portion of the P-type region 11A, the second compensation doped region 31B has been arranged in the side wall portion of the N-type region 11B, and optical loss is thus able to be reduced.

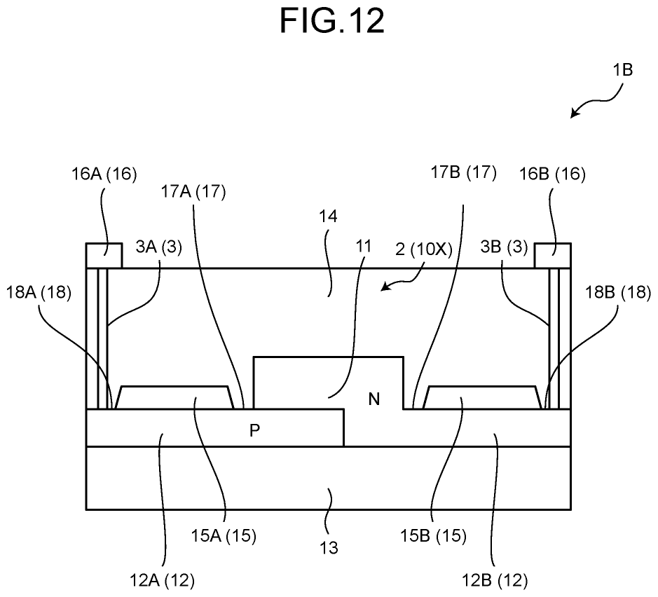

A case where the core 10 in the optical modulator element 1A according to the third embodiment includes a PN junction having a lateral structure has been described as an example, but without being limited to this example, modifications can be made as appropriate. FIG. 12 is a diagram illustrating an example of a schematic cross section of another optical modulator element 1B. A core 10X in the optical modulator element 1B illustrated in FIG. 12 is a core including a PN junction having a vertical structure. The core 10X including the PN junction having the vertical structure has a long interface between a P-type region 11A and an N-type region 11B and is thus high in optical modulation efficiency. The optical modulator element 1B including the core 10X with the PN junction having the vertical structure also enables reduction of the horizontal extension of the electric field distribution and thereby enables reduction of optical loss and reduction of generation of higher-order modes. What is more, for example, because a first metal electrode 3A and a second metal electrode 3B are arranged to overlap high-concentration doped regions, optical absorption is able to be reduced, as compared with the optical modulator element 100 of the comparative example.

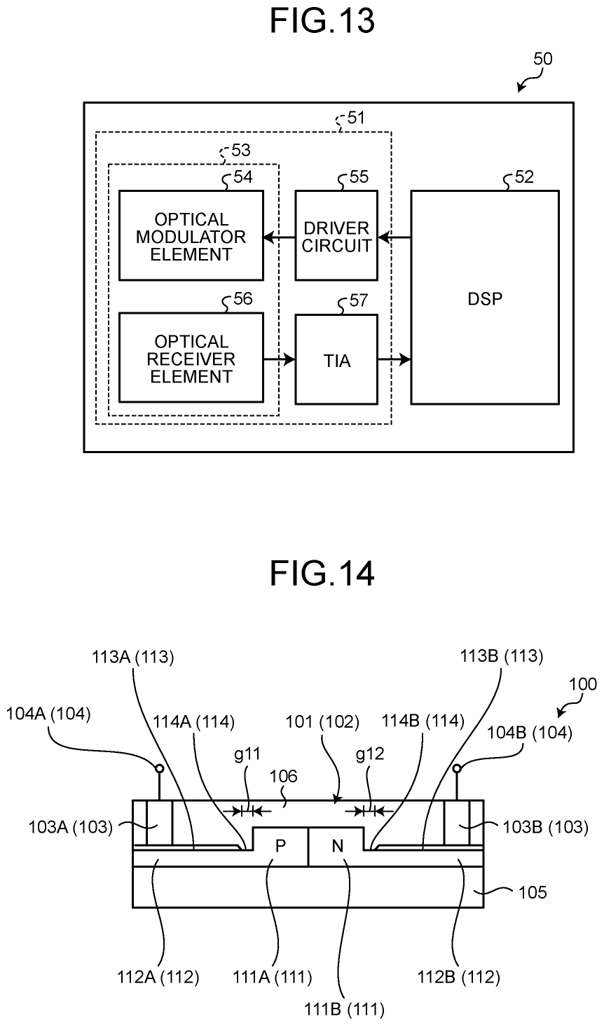

An optical transceiver 50 adopting the optical modulator element 1 according to the embodiment will be described next. FIG. 13 is a block diagram illustrating an example of the optical transceiver 50 according to the embodiment. The optical transceiver 50 illustrated in FIG. 13 has an optical transmitter and receiver 51 and a digital signal processor (DSP) 52. The optical transmitter and receiver 51 has an optical modulator element 54, a driver circuit 55, an optical receiver element 56, and a transimpedance amplifier (TIA) 57. The DSP 52 controls the overall optical transmitter and receiver 51. The DSP 52 is an electric component that executes IQ modulation processing of a transmitted signal, demodulation processing of a received signal, and digital signal processing.

For example, the DSP 52 executes processing, such as encoding of transmitted data, generates an electric signal including the transmitted data, and outputs the electric signal generated, to the driver circuit 55. The driver circuit 55 drives the optical modulator element 54 according to the electric signal from the DSP 52. The optical modulator element 54 performs optical modulation of signal light.

The optical receiver element 56 performs electric conversion of signal light. The TIA 57 amplifies an electric signal that has been electrically converted and outputs the electric signal that has been amplified, to the DSP 52. The DSP 52 obtains received data by executing processing, such as decoding of the electric signal obtained from the TIA 57.

Because a first thin film 15A and a second thin film 15B in the optical modulator element 54 are laterally finite, a first metal electrode 3A and a P-type slab region 12A are directly connected to each other and a second metal electrode 3B and an N-type slab region 12B are directly connected to each other. As a result, the horizontal extension of the electric field distribution is lessened and optical loss and generation of higher-order modes are thereby able to be reduced. What is more, for example, because the first metal electrode 3A and the second metal electrode 3B are arranged to overlap high-concentration doped regions, optical absorption is able to be reduced, as compared with the optical modulator element 100 of the comparative example.

For convenience of description, a case where the optical modulator element 54 and the optical receiver element 56 have been built in the optical transceiver 50 has been described as an example, but modifications may be made as appropriate, and the optical transceiver 50 may be an optical transmitter having only the optical modulator element 54 built therein.

Furthermore, the components of each unit illustrated in the drawings may be not configured physically as illustrated in the drawings. That is, specific forms of distribution and integration of each unit are not limited to those illustrated in the drawings, and all or part thereof may be configured to be functionally or physically distributed or integrated in any units according to various loads and use situations.

Furthermore, all or any part of various processing functions executed in the respective devices may be executed on a central processing unit (CPU) (or a microcomputer, such as a micro processing unit (MPU) or a micro controller unit (MCU)). Furthermore, all or any part of the various processing functions may of course be executed on a program analyzed and executed by a CPU (or a microcomputer, such as an MPU or MCU) or on hardware by wired logic.

In one aspect, what is able to be provided is an optical modulator element that enables reduction of deterioration in quality of optical signals and reduction of optical loss while reducing generation of higher-order modes.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical modulator element, comprising:
a rib optical waveguide including a rib portion having a PN junction, a P-type slab region connected to a P-type region of the rib portion, and an N-type slab region connected to an N-type region of the rib portion;
a first thin film formed on the P-type slab region and having electron affinity different from electron affinity of a material for the P-type slab region;
a first high-concentration doped region in the P-type slab region, the first high-concentration doped region being at a position separate from the rib portion; and
a first metal electrode electrically connected to the first high-concentration doped region positioned outward in the P-type slab region having the first thin film formed on the P-type slab region.

2. The optical modulator element according to claim 1, wherein the first thin film is formed on the P-type slab region, with a gap between the first thin film and the first metal electrode.

3. The optical modulator element according to claim 1, wherein the first thin film includes a material having electron affinity smaller than the electron affinity of the material for the P-type slab region.

4. The optical modulator element according to claim 1, wherein the first thin film is in an undoped state of not having been doped intentionally.

5. The optical modulator element according to claim 1, wherein the first thin film is formed on the P-type slab region, with a gap between the first thin film and a side wall of the rib portion.

6. The optical modulator element according to claim 1, wherein at least part of the first thin film is formed on the first high-concentration doped region.

7. The optical modulator element according to claim 1, further including:
a second thin film formed on the N-type slab region and having electron affinity different from electron affinity of a material for the N-type slab region;
a second high-concentration doped region in the N-type slab region, the second high-concentration doped region being at a position separate from the rib portion; and
a second metal electrode electrically connected to the second high-concentration doped region positioned outward in the N-type slab region having the second thin film formed on the N-type slab region.

8. The optical modulator element according to claim 7, wherein the second thin film is formed on the N-type slab region, with a gap between the second thin film and the second metal electrode.

9. The optical modulator element according to claim 7, wherein the second thin film includes a material having electron affinity smaller than the electron affinity of the material for the N-type slab region.

10. The optical modulator element according to claim 7, wherein the second thin film is in an undoped state of not having been doped intentionally.

11. The optical modulator element according to claim 7, wherein the second thin film is formed on the N-type slab region, with a gap between the second thin film and a side wall of the rib portion.

12. The optical modulator element according to claim 7, wherein at least part of the second thin film is formed on the second high-concentration doped region.

13. The optical modulator element according to claim 7, wherein the rib optical waveguide includes silicon, and the first thin film and the second thin film include germanium.

14. The optical modulator element according to claim 13, wherein the first thin film and the second thin film include silicon and germanium, and a composition ratio of the germanium is at least 0.2 to 0.4.

15. The optical modulator element according to claim 13, wherein a covering layer including silicon covers surfaces of the first thin film and the second thin film.

16. An optical transmitter comprising an optical modulator element that performs optical modulation of light by using a transmitted signal and transmits transmitted light, wherein the optical modulator element including:
a rib optical waveguide including a rib portion having a PN junction, a P-type slab region connected to a P-type region of the rib portion, and an N-type slab region connected to an N-type region of the rib portion;
a first thin film formed on the P-type slab region and having electron affinity different from electron affinity of a material for the P-type slab region;
a first high-concentration doped region in the P-type slab region, the first high-concentration doped region being at a position separate from the rib portion; and
a first metal electrode electrically connected to the first high-concentration doped region positioned outward in the P-type slab region having the first thin film formed on the P-type slab region.

17. The optical transmitter according to claim 16, wherein the optical modulator element further includes:
a second thin film formed on the N-type slab region and having electron affinity different from electron affinity of a material for the N-type slab region;
a second high-concentration doped region in the N-type slab region, the second high-concentration doped region being at a position separate from the rib portion; and
a second metal electrode electrically connected to the second high-concentration doped region positioned outward in the N-type slab region having the second thin film formed on the N-type slab region.

18. An optical transceiver, comprising:
an optical modulator element that performs optical modulation of light by using a transmitted signal and transmits transmitted light; and
an optical receiver element that receives a received signal from received light by using light,
wherein the optical modulator element includes:
a rib optical waveguide including a rib portion having a PN junction, a P-type slab region connected to a P-type region of the rib portion, and an N-type slab region connected to an N-type region of the rib portion;
a first thin film formed on the P-type slab region and having electron affinity different from electron affinity of a material for the P-type slab region;
a first high-concentration doped region in the P-type slab region, the first high-concentration doped region being at a position separate from the rib portion; and
a first metal electrode electrically connected to the first high-concentration doped region positioned outward in the P-type slab region having the first thin film formed on the P-type slab region.

19. The optical transceiver according to claim 18, wherein the optical modulator element further includes:
a second thin film formed on the N-type slab region and having electron affinity different from electron affinity of a material for the N-type slab region;
a second high-concentration doped region in the N-type slab region, the second high-concentration doped region being at a position separate from the rib portion; and
a second metal electrode electrically connected to the second high-concentration doped region positioned outward in the N-type slab region having the second thin film formed on the N-type slab region.
